(19) United States
(12) Patent Application Publication
(10) Pub. No.: US 2014/0098466 A1
(43) Pub. Date: Apr. 10, 2014

(54) Electrolyte

(71) Applicants: Alexander Bilyk, McKinnon (AU); Phillip Brett Aitchison, Neutral Bay (AU); Allan Godsk Larsen, Valby (DK); John Chi Hung Nguyen, Wattle Grove (AU); Nicole van der Laak, Epping (AU)

(72) Inventors: Alexander Bilyk, McKinnon (AU); Phillip Brett Aitchison, Neutral Bay (AU); Allan Godsk Larsen, Valby (DK); John Chi Hung Nguyen, Wattle Grove (AU); Nicole van der Laak, Epping (AU)

(73) Assignee: CAP-XX LIMITED, Dee Why, New South Wales (AU)

(21) Appl. No.: 14/115,982

(22) PCT Filed: May 7, 2012
(86) PCT No.: PCT/AU2012/000480

§ 371 Date: Nov. 6, 2013

(30) Foreign Application Priority Data
May 10, 2011 (AU) 2011901763

(51) Int. Cl. H01G 11/64

(52) U.S. Cl. CPC H01G 11/64
USPC 361/502; 252/62.2

(57) ABSTRACT

An electrolyte system suitable for use in an energy storage device (such as a supercapacitor), and energy devices which comprising the electrolyte system which is made up of an ionic liquid, such as Li or EMI TFSI and a stabilising amount of a stabilising additive. The stabilising additive preferably contains nitrile and or aromatic (benzene) groups, and may be advantageously benzonitrile, cinnamonitrile or succinonitrile. The stabilising additive stabilises the energy storage device against ESR rise and/or capacitance loss but does not adversely affect other performance characteristics of the ionic liquid.

### TECHNICAL FIELD

The invention relates to electrolytes for use in energy storage devices. In particular, the invention relates to non-aqueous electrolytes capable of providing improved performance in batteries, capacitors, supercapacitors and the like.

The invention has been developed primarily for supercapacitors and will be described hereinafter with reference to that application. It will be appreciated, however, that the invention is not limited to that particular field of use and is also suitable for other energy storage devices such as batteries, fuel cells, pseudocapacitors and capacitors and hybrids of one or more of these devices.

### BACKGROUND OF THE INVENTION

Any discussion of the prior art throughout the specification should in no way be considered as an admission that such prior art is widely known or forms part of common general knowledge in the field.

Supercapacitors are also referred to as ultra capacitors, electrochemical double layer capacitors (EDLC) and electrochemical capacitors, amongst others, all of which are included within the term “supercapacitor” as used within this specification.

Supercapacitors generally enable fast (high power) delivery of energy with the amount of energy delivered being very high compared to ordinary capacitors, but low compared to batteries. Low resistance, high energy density, supercapacitors are ideally suited for high power applications such as:
Wireless communications with limited power supplies such as:
Mobile/cellular telephones; PC card; CF card; mini PCI; express card; USB modems; PDA's; automatic meter reading; toll tags; GPS, GPRS and RF tracking.
Energy back-up (UPS) in portable, or space constrained devices.
Voltage regulation for CPU's; automotive vehicles; portable audio and other devices with high surge loads.
High energy, high power electrical loads, such as: Actuators for door locks; DSC's and LED flash for cameras.
Solid state memory storage devices (egg. solid state hard drives).

Supercapacitors can play a role in hundreds of applications. The energy and power storage markets, where supercapacitors reside, are currently dominated by batteries and capacitors. It is well recognised that batteries are good at storing energy but compromise design to enable high power delivery of energy. It is also well recognised that capacitors enable fast (high power) delivery of energy, but that the amount of energy delivered is very low (low capacitance).

Overlaying these limitations of existing batteries and capacitors against market demand reveals the three main areas of opportunity for supercapacitors: battery replacement devices, which have high energy density; battery complement devices, which have high power and energy densities; and capacitor replacement devices which are smaller and not only have high power density but have high frequency response.

Currently, the relatively high power density of supercapacitors make them ideal for series or parallel combination with batteries that have high energy density to form a hybrid energy storage system. When a load requires energy that is not constant, complementing the battery with a supercapacitor allows the peaks to be drawn from the charged-up supercapacitor. This reduces the load on the battery and in many cases extends the lifecycle of a battery as well as the lifetime of rechargeable batteries.

Supercapacitors also have application in the field of Hybrid Electric Vehicles (HEV). Supercapacitors can be used as an integral component of the drivetrains of these vehicles and are used as the primary power source during acceleration and for storage of energy reclaimed during regenerative braking.

Supercapacitors store energy by means of separation of charge rather than by the electro-chemical process inherent in a battery. They generally include two opposed electrodes electrically isolated by an intermediate electronically insulating separator which is porous and permeated by an electrolyte. Two current collecting terminals generally connect to and extend from respective electrodes for allowing external access to the electrodes. The housing is sealed to preventingress of contaminants and egress of electrolyte. Multiple electrode capacitors have also been constructed, for example, lithium ion capacitors are a hybrid device possessing a third electrode.

Capacitance, the ability to store an electrical charge, arises when two parallel plates are connected to an external circuit and a voltage difference is imposed between the two plates. In such a case, the surfaces become oppositely charged. The fundamental relationship for this separation of charges is described by the following equation

$$C = \frac{ɛ A}{L}$$

where C denotes capacitance with a unit of farads (F), c is the permittivity with a unit of farads per metre (m), A is the area of overlap of the charged plates and L is the separation distance. The permittivity of the region between the plates is related to the dielectric constant of the material that can be used to separate the charged surfaces.

The problem with existing commercial capacitors using conventional materials is that their performance is limited by their dimensions. For example, a capacitor based around a metallised coating of a polyethylene sheet that is 50 μm thick will develop only 0.425 μF for one square metre of capacitor. Thus, over 2.3 million square metres will be required to develop 1 F.

The supercapacitors developed by the present Applicant are disclosed in detail in the Applicant's co-pending applications, for example, PCT/AU98/00406 (WO 98/054739), PCT/AU99/00278 (WO 99/053510), PCT/AU99/00780 (WO 00/016352), PCT/AU99/01081 (WO 00/034964), PCT/AU00/00836 (WO 01/004920), PCT/AU01/00553 (WO 01/089058), the contents of which are incorporated herein by reference.

These supercapacitors developed by the Applicant overcome the dimensionality problem described above by using as a coating material an extremely high surface area carbon.

These supercapacitors include two opposed electrodes maintained in a predetermined spaced apart electrically isolated configuration by an intermediate electronically insulating separator. The electrodes consist of metal current collectors and a coating material typically formed from particulate carbon and a binder used for adhering the carbon to itself and to the associated current collector.

The coated electrodes and intermediate separator can be either stacked or wound together and disposed within a housing that contains an electrolyte. Two current collecting terminals are then connected to and extend from respective electrodes for allowing external access to those electrodes. The housing is sealed to prevent the ingress of contaminants and the egress of the electrolyte. This allows advantage to be taken of the electrical double layer that forms at the interface between the electrodes and the electrolyte. That is, there are two interfaces, those being formed between the respective electrodes and the electrolyte. This type of energy storage device is known as a supercapacitor. Alternatively, these have been known as ultracapacitors, electrical double layer capacitors and electrochemical capacitors.

The electrolyte contains ions that are able to freely move throughout a matrix, such as a liquid or a polymer, and respond to the charge developed on the electrode surface. The double layer capacitance results from the combination of the capacitance due to the compact layer (the layer of solvated ions densely packed at the surface of the electrode) and the capacitance due to the diffuse layer (the less densely packed ions further from the electrode).

In supercapacitors, the charge separation in the compact layer is generally very thin, less than a nanometre, and of very high surface area. This is where the technological advantage for supercapacitors over conventional capacitors lies, as charge storage in the compact layer gives rise to high specific capacitances. This is an increase by several hundred thousand-fold over conventional film capacitors. As well, the applied potential controlled, reversible nano scale ion adsorption/desorption processes result in a rapid charging/discharging capability for supercapacitors.

The electrode material may be constructed as a bed of highly porous carbon particles with a very high surface area. For example, surface areas may range from 100 m² per gram up to greater than 2500 m² per gram in certain preferred embodiments. The carbon matrix is held together by a binding material that not only holds the carbon together (cohesion) but it also has an important role in holding the carbon layer onto the surface of the current collecting substrate (adhesion).

The current collecting substrate is generally a metal foil. The space between the carbon surfaces contains an electrolyte (frequently solvent with dissolved salt). The electrolyte is a source of ions which is required to form the double layer on the surface of the carbon as well as allowing ionic conductance between opposing electrodes. A porous separator is employed to physically isolate the carbon electrodes and prevent electrical shorting of the electrodes.

The energy storage capacity for a supercapacitor can be described by the equation:

$$E = \frac{1}{2} {CV}^{2}$$

where E is the energy in joules and V is the rated or operating voltage of the supercapacitor.

Apart from the voltage limitation, it is the size of the supercapacitor that controls the amount of stored energy, and the distinguishing feature of supercapacitors is their particularly high values of capacitance. Another measure of supercapacitor performance is the ability to store and release the energy rapidly; this is the power, P, of a supercapacitor and can be given by:

$$P = \frac{{V}^{2}}{4 R}$$

where R is the internal resistance of the supercapacitor. For capacitors, it is more common to refer to the internal resistance as the equivalent series resistance or ESR. As can be deduced from the foregoing equations, the power performance is strongly influenced by the ESR of the entire device, and this is the sum of the resistance of all the materials, for instance, substrate, carbon, binder, separator, electrolyte and the contact resistances as well as between the external contacts. Lower ESR for a device gives better device performance.

In many cases, the physical and electrochemical properties of electrolytes are a key factor in determining the internal resistance (ESR) of the supercapacitor and the “power spectrum” of the supercapacitor, i.e. the ability of the supercapacitor to provide power over various time domains or in various frequency ranges. By correct selection of the supercapacitor components in combination, it is possible to reduce ESR.

One means of reducing the ESR of a supercapacitor is to use more conductive electrolytes. The combination of more conductive active materials with thinner design allows higher powers to be achieved while maintaining or reducing the mass and/or volume.

The product of resistance and capacitance (RC), commonly referred to as the time constant, is frequently used to characterise capacitors. In an ideal capacitor, the time constant is frequency independent. However, in carbon based supercapacitors, both R and C are frequency dependent. This arises from the microporous characteristics of high surface area carbons, and the nature of charge build up at the electric double layer on the carbon surface. The traditional method of measuring R and C for supercapacitors is to use a constant current charge or discharge and to measure the voltage jump at the start or finish of the cycle, and the rate of change of voltage during the cycle respectively. This however effectively provides the R at high frequency and the C at low frequency. Another more suitable method is to measure the frequency response of the complex impedance and to model a simple RC element to the data. This provides an estimate of R and C across the frequency range that may or may not correlate with those measured using constant current techniques.

Clearly, the use of RC time constant as a measure of capacitor suitability is subject to a large uncertainty. A more useful technique has recently been proposed in which R and C are measured at the frequency at which the phase angle of current and voltage is −45°. The reciprocal of this frequency is the “response time” and is more clearly defined than other methods. Further, the capacitance at this frequency can then be used to calculate the energy and provide a Figure of Merit (FOM) when normalised with the mass or volume of the supercapacitor.

It will be appreciated that a gravimetric FOM is more appropriate for use with energy storage devices intended for pulse power applications. That is, such applications are by necessity frequency dependent and, as such, the calculation of the figure of merit involves first identifying the frequency fₒ at which the impedance of the storage device reaches a −45° phase angle. A reciprocal of fₒ then provides a characteristic response time Tₒ for the storage device. The value of the imaginary part of the impedance Z″ at fₒ is used to calculate the energy Eₒ that the device is able to provide at that frequency. More particularly, using:

Eₒ=½CV²

where C=−1/(2πfₒZ″) and V is the rated voltage of the device, the gravimetric figure of merit is calculated by dividing Eₒ by the mass (m) of the device and by Tₒ. That is, gravimetric FOM=Eₒ/(m·Tₒ).

The gravimetric figure of merit has been suggested by John R. Miller in a paper entitled “Pulse Power Performance of Electrochemical Capacitors: Technical Status of Present Commercial Devices” for the “8th International Seminar on Double Layer Capacitors and Similar Energy Storage Devices”, Deerfield Beach, Fla., Dec. 7-9, 1998. The teachings of and disclosure within that paper are incorporated herein by way of cross-reference.

Also detailed in the Miller paper is the calculation of a volumetric figure of merit (volumetric FOM) which is based upon Eₒ divided by both Tₒ and the volume of the device. The volumetric FOM is expressed in terms of Watts/cm³.

These figures of merit provide a different characterisation of storage devices which is more in keeping with the frequency dependent nature of pulse power and other such applications to which the devices are being applied. It should also be noted that the performance of the devices cannot be adequately explained by the hitherto utilised simple RC model. Such simple models do not account for the frequency dependent nature of either pulsed or high power applications, whereas the FOM used to characterise the present invention is a parameter directly relevant to such applications.

Another figure useful in assessing the performance of a supercapacitor is Effective Capacitance (Ce). Effective Capacitance (Ce) is the capacitance obtained during a constant current discharge at a specified time and is derived from an RC electrical model of the supercapacitor's measured discharge, where R (or ESR) is measured at a predetermined time, say 20 μs (microseconds) and held constant in the model. The discharge current used here is typically 100 mA. Ce is thus time dependant. The weight used here to calculate the specific gravimetric Effective Capacitance in a supercapacitor is generally the total mass of the device. For dissimilarly packaged or structured devices, a comparison of Ce may be made by comparing the mass of the active coatings, or active materials within coatings, for the devices.

As well as meeting the above electrochemical criteria, there are other practical requirements necessary for a good electrolyte system.

Firstly, there is the necessity for the electrolyte to be chemically stable. Aqueous based electrolytes, such as sulfuric acid and potassium hydroxide solutions, are often used as they enable production of an electrolyte with high conductivity. However, water is susceptible to electrolysis to hydrogen and oxygen on charge and as such has a relatively small electrochemical window of operation outside of which the applied voltage will degrade the solvent. In order to maintain electrochemical stability in applications requiring a voltage in excess of 1.0 V, it is necessary to employ supercapacitor cells in series, which leads to an increase in size, a reduction in capacitance and an increase in ESR in relation to a non-aqueous device which is capable of producing an equivalent voltage. Stability is important when one considers that the supercapacitors may remain charged for long periods and must charge and discharge many hundreds of thousands of times during the operational lifetime of the supercapacitor.

Secondly, it must be borne in mind when selecting the electrolyte system that supercapacitors do not operate in isolation. Rather, in use, they are in confined environments in the presence of components which generate high temperatures. Supercapacitors must also be capable of operation at low temperatures.

Thirdly, as supercapacitors evolve and are being pushed to higher levels of performance, that is as supercapacitors are pushed towards higher operating voltages and temperatures, the measurement criteria for their performance becomes more stringent. One measurement of ongoing supercapacitor performance is the ESR rise rate—this is the upward drift in ESR over time towards unacceptably high levels. ESR rise rate is a function of the overall stability of the system relative to time, temperature and voltage and the number of times a device cycles. Typical electrolytes in many cases exhibit unacceptably high ESR rise rates.

Accordingly, as the field of supercapacitors evolves, there is a continuing need for new solvents and electrolyte systems that exhibit better stability and operational characteristics.

It is an object of the present invention to provide a non-aqueous electrolyte suitable for use in the energy storage device which overcomes one or more of the above mentioned disadvantages, or at least provides a commercially viable alternative.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Although the invention will be described with reference to specific examples it will be appreciated by those skilled in the art that the invention may be embodied in many other forms.

### SUMMARY OF THE INVENTION

In a first aspect, the invention provides an electrolyte system suitable for use in an energy storage device, the electrolyte system comprising an ionic liquid and a stabilising amount of a stabilising additive.

Ionic liquids (ILs) are low melting temperature salts that form liquids comprised of cations and anions. According to current convention, a salt melting below the boiling point of water is known as an ionic liquid or by one of many synonyms including low/ambient/room temperature molten salt, ionic fluid, liquid organic salt, fused salt, and neoteric solvent.

Anions that form room temperature ionic liquids are usually weakly basic inorganic or organic compounds that have a diffuse or protected negative charge. Cations that produce low melting point ionic liquids on the other hand are generally organic species with low symmetry and include for example imidazolium, pyrazolium, triazolium, thiazolium, and oxazolium cations.

Ionic liquids have the advantage over conventional electrolytes in that they are generally non-volatile, non-flammable, and exhibit relatively high ionic conductivity.

The highest acceptable melting temperature for an IL suitable for use in a supercapacitor is about −10° C. Below this melting point the IL should preferably behave as a good glass former. That is, below its melting points, the super-cooled ionic liquid should retain liquid character, or the essential characteristics of a liquid, until the glass temperature is reached.

Due to cold start-up temperatures, which may be experienced by a superconductor in an electrical device, suitable ILs should preferably possess liquid characteristics below about −10° C., more preferably below about −20° C., even more preferably below about −30° C. and most preferably below about −40° C.

As supercapacitors are typically used in confined environments in the presence of components which generate high temperatures, ILs should also be stable at normal operating temperature of about 85° C., more preferably about 100° C., and even more preferably about 130° C.

The energy storage device may be exposed to external temperatures as high as 260° C. during assembly into the device of final application. These processes are often referred to as surface mount or reflow. It is desirable that the electrolyte within the energy storage device be able to withstand such assembly processes.

The energy storage device may be a battery, capacitor, or more preferably, a supercapacitor.

The term “stabilising additive” as used herein refers to the ability of the additive to stabilise one or more performance properties of the capacitor over time. The stabilising additive preferably stabilises the ESR of the energy storage device. The stabilising additive may alternatively, or in addition, reduce capacitance loss of the energy storage device.

Preferably the stabilising additive does not adversely affect other performance characteristics of the ionic liquid electrolyte, for instance, the stabilising additive does not adversely affect device ESR, capacitance, self discharge or operating temperatures and voltage windows. More preferably the additive may also improve other performance characteristics.

The ionic liquid may be for example [MeMeIm][N(CF₃SO₂)₂]; [EtMeIm][BF₄]; [EtMeIm][C(CF₃SO₂)₂]; [EtMeIm][N(CF₃SO₂)₂]; [EtMeIm][CF₃CO₂]; [EtMeIm][CF₃SO₃]; [EtMeIm][CF₃CO₂]; [EtMeIm][N(CF₃SO₂)₂]; [EtMeIm][N(C₂F₅SO₂)₂]; [EtMeIm][N(CN)₂]; [EtEtIm][CF₃SO₃]; [EtEtIm][N(CF₃SO₂)₂]; [1,2-Meₑ-3-EtIm][N(CF₃SO₂)₂]; [1-Et-2,3-Me₂Im][N(CF₃SO₂)₂]; [1-Et-3,5-Me₂Im][N(CF₃SO₂)₂]; [1-Et-3,5-Me₂Im][CF₃SO₃]; [1-Et₂-3,5-MeIm][N(CF₃SO₂)₂]; [1,2-Et₂-3-MeIm][N(CF₃SO₂)₂]; [1,3-Et₂-4-MeIm][N(CF₃SO₂)₂]; [1,3-Et₂-5-MeIm][N(CF₃SO₂)₂]; [BuMeIm][BF₄]; [BuMeIm][PF₆]; [BuMeIm][N(CF₃SO₂)₂]; [BuMeIm][CF₃SO₃]; [BuMeIm][C₄F₉SO₃]; [BuMeIm][N(CF₃SO₂)₂]; [iBuMelm][N(CF₃SO₂)₂]; [BuEtIm][N(CF₃SO₂)₂]; [BuEtIm][CF₃CO₂]; [BuMeIm][C₄F₉SO₂]; [BuMeIm][C₃F₇CO₂]; [BuMeMeIm][BF₄]; [BuMeMeIm][PF₆]; [PrMeIm][BF₄]; [PrMeMeIm][N(CF₃SO₂)₂]; [iPrMeIm]][N(CF₃SO₂)₂]; [1,2-Meₑ-3-PrIm][N(CF₃SO₂)₂]; [MeMePy][CF₃SO₂NCOCF₃]; [EtMePy][N(CN)₂]; [PrMePy][N(CF₃SO₂)₂]; [PrMePy][N(CN)₂]; [HexMePy][N(CN)₂]; [Me₃BuN][CF₃SO₂NCOCF₃]; [Me₃Et_{4][CF}₃SO₂NCOCF₃]; [PrMe₃N][N(CF₃SO₂)₂]; [Et₄N][N(CF₃SO₂)₂]; [MePrPp][N(CF₃SO₂)₂]; [BuPi][BF₄]; or [BuPi][N(CF₃SO₂)₂].

The ionic liquid may be a TFSI salt, for example, a Li or EMI TFSI salt. Preferably the ionic liquid is EMITFSI (1-ethyl-3-methylimidazolium bis(trifluoromethane-sulfonyl)imide).

The stabilising additive preferably functions at least as a water scavenger.

The stabilising additive is preferably contains nitrile groups. The stabilising additive preferably contains an aromatic ring, more preferably a benzene ring. One preferred class of stabilising additive is that containing both an aromatic ring and a nitrile group.

In one particular embodiment the stabilising additive is contains a benzene ring and one or more nitrile groups.

In one particular embodiment the stabilising additive is selected from the group consisting of benzonitrile, cinnamonitrile and succinonitrile. In another particular embodiment the stabilising additive is selected from the group consisting of benzonitrile and cinnamonitrile. In another particular embodiment the stabilising additive is selected from the group consisting of benzonitrile and succinonitrile. In another particular embodiment the stabilising additive is selected from the group consisting of cinnamonitrile and succinonitrile.

The most preferred stabilising additive is benzonitrile.

The stabilising additive may be present in an amount of up to 50% wt/wt, alternatively up to 30% wt/wt, alternatively up to 25% wt/wt, alternatively up to 20% wt/wt, alternatively up to 55% wt/wt, alternatively up to 10% wt/wt, alternatively up to 5% wt/wt, alternatively up to 1% wt/wt, or alternatively up to 0.25% wt/wt. There are instances where commercial imperatives will make greater than 50% wt/wt desirable.

One useful combination is EMITSFI/benzonitrile, for example, 5% benzonitrile in EMITFSI; 1% benzonitrile in EMITFSI or 0.25% benzonitrile in EMITFSI.

In a second aspect, the invention provides an energy storage device comprising an electrolyte system comprising an ionic liquid and a stabilising amount of a stabilising additive.

The electrolyte system is preferably as described above in relation to the first aspect.

Preferably the energy storage device is in the form of a supercapacitor.

The stabilising additive is provided to stabilise either or both of the ESR or capacitance of the energy storage device at predetermined voltage, typically the operating voltage.

Preferably the stabilising additive does not adversely affect other performance characteristics of the device, such as, for example, ESR, capacitance, capacitance decay rate, self discharge or operating temperatures and voltage windows.

Preferably the energy storage device of the present invention has an ESR rise rate that is less than the ESR rise rate of an equivalent device without the stabilising additive and/or a capacitance loss rate that is less than the capacitance loss rise of a device without the stabilising additive at a working voltage and temperature where the equivalent device without the stabilising additive shows significant ESR rise rate and or C loss rate.

Preferably the electrolyte of the present invention has a conductivity of no less than +/−5% of the conductivity of an electrolyte without the stabilising additive at a predetermined temperature range. Although instances where conductivity is sacrificed for other benefits can be envisaged.

Preferably the energy storage device of the present invention has a capacitance of no less than +/−5% of an equivalent device without the stabilising additive at a predetermined voltage and temperature. Although instances where capacitance is sacrificed for other benefits can be envisaged.

Preferably the energy storage device of the present invention has an increased operating voltage window relative to that of an equivalent device without the stabilising additive at a predetermined voltage and temperature.

### DESCRIPTION

The present Applicant has surprisingly found that the responsiveness and long term performance of ionic liquid supercapacitors can be increased by the addition of certain organic additives.

Surprisingly, it has been found that using an ionic liquid such as EMITFSI (1-ethyl-3-methylimidazoliumbis(trifluoromethane-sulfonyl)imide) in combination with a stabilising agent such as benzonitrile, in a supercapacitor provides a significant benefit in terms of reduced ESR rise and retained capacitance over long periods of time, when subject to life testing at elevated temperature and voltage compared to supercapacitor that uses ionic liquid electrolyte without the stabilising additive.

### EXAMPLES

The present invention is represented by the following non-limiting Examples.

Prior to considering the data presented in these Examples, the Applicant wishes to clarify that the difference in the ESR data for the two EMITFSI controls (see, Examples 1.1 and 2.1), is due to the Inventors having used a different, active high surface area carbon in Example 2. Moreover, in Example 2, the separator thickness was different: a 25 μm, high porosity PTFE separator was used.

### Example 1

### Benzonitrile Additive

The supercapacitors were prepared in accordance with methods disclosed in the Applicant's previous published patent specifications (see, for example, PCT/AU98/00406 (WO 98/054739), PCT/AU99/00278 (WO 99/053510), PCT/AU99/00780 (WO 00/016352), PCT/AU99/01081 (WO 00/034964), PCT/AU00/00836 (WO 01/004920), PCT/AU01/00553 (WO 01/089058)).

Electrode sheets were formed from carbon coatings on 22 μm thick aluminium foil, where the carbon coating included an activated carbon, a binder and a conductive carbon. Cells were made by separating two 29 cm² of approximately 6 μm thick carbon coated electrode with a porous separator of 13 μm thick polytetrafluoroethylene. The whole was then folded in half to form a flat electrode stack with bare aluminium tabs extending from each electrode. The stack was then partly enclosed in a laminate package with an EAA heat seal layer to make a supercapacitor cell. This packaged dry cell was then dried in an inert atmosphere. While still in an inert atmosphere, each stack was saturated with EMITFSI or a mix of EMITFSI with benzonitrile and the package vacuum sealed. The cell was then put on life test with the following conditions: charged to 2.3 V and heated to 70° C. for 1000 h and the ESR was measured every hour by voltage drop and the Capacitance was recorded every 6 hours from constant current discharge of 100 mA between 1.5 V and 0.5 V. ESR rise rates and Capacitance loss were determined from the life data between 900 and 1000 h. The results are summarised in Table 1. Examples 1.1 to 1.3 use the same batch of electrode coatings which give slightly lower initial capacitance to the electrode used in examples 1.4 to 1.8.

All cells were cycled between 0.5 and 2.3 V 100 times before measuring electrical properties.

TABLE 1
Average ESR and capacitance at different points during life testing at 70° C.
and 2.3 V, with associated change rates (values in parenthesis are standard
deviation), illustrating the benefits of benzonitrile addition.

| | % Benzonitrile | Average | | ESR rise | C loss rate |
|---|---|---|---|---|---|
| Example | in EMITFSI by | Initial ESR | Initial C (F) | rate (mΩ/ | (mF/ |
| No. | weight | (mΩ) at 23° C. | at 23° C. | 1000 h) | 1000 h) |
| 1.1 | 0 | 60 (2) | 0.570 (0.009) | 33 (17) | 213 (34) |
| 1.2 | 0.25 | 58 (2) | 0.573 (0.004) | 4.3 (0.9) | 33 (18) |
| 1.3 | 1 | 56.0 (0.7) | 0.58 (0.01) | 4.6 (0.6) | 28 (5) |
| 1.4 | 0 | 60.5 (0.8) | 0.67 (0.01) | 25 (9) | 248 (21) |
| 1.5 | 5 | 56 (1) | 0.71 (0.01) | 6 (2) | 23 (7) |
| 1.6 | 10 | 53 (1) | 0.71 (0.01) | 4 (1) | 26 (8) |
| 1.7 | 25 | 46.4 (0.8) | 0.70 (0.01) | 3 (1) | 25 (10) |
| 1.8 | 50 | 44.7 (0.6) | 0.71 (0.01) | 6 (2) | 41 (9) |

From these examples in Table 1 it is clear that addition of benzonitrile to the EMITFSI electrolyte significantly reduces both the initial ESR and the change in ESR during the life test at 70° C. and 2.3 V. A similar benefit is seen in capacitance, where initial capacitance is higher and capacitance loss is lower. Example 1.2 shows that even 0.25% benzonitrile in EMITFSI has a very positive effect on cell performance.

The additive also significantly reduces initial ESR, which is beneficial for device function.

In terms of electrolyte performance, benzonitrile mixes well with ionic liquids such as EMITFSI at a range of concentrations at ambient temperatures to provide a homogeneous solution. Peak conductivities were obtained at around 25% wt/wt benzonitrile in ionic liquid. The peak conductivity was about 11.5 mS/cm for EMITFSI (cf. about 7.8 mS/cm neat EMITFSI) and 14.5 mS/cm for EMITFB (cf. about 12.5 mS/cm neat EMITFB).

The long term viability of a supercapacitor can be measured by determining its ESR rise over time. ESR tends to drift upwards as the capacitor ages through use or storage. The lower the rate rise, the longer the supercapacitor can maintain an acceptably low ESR figure.

It can be seen that at the start of the device life, the ESR of the device tested was lower when benzonitrile was present and after several hundred hours, there is a clear improvement in terms of the ESR rise rate and capacitance loss suppression exhibited by the devices containing benzonitrile.

Thus, the addition of 1% benzonitrile reduced the ESR rise rate from about 0.033 mΩ/h down to around 0.003-0.006 mΩ/h. This represents a reduction to around 25% of the ESR rise rate, which potentially corresponds to an approximate four-fold extension of device life.

In addition to reducing ESR rise rate, the addition of benzonitrile to ionic liquid electrolytes was seen to minimise capacitance decay rate. In the EMTISFI system, capacitance decay was around 2×10⁻⁴ F/h, whereas in the EMISTFI/benzonitrile systems, it was around 3×10⁻⁵ F/h, a reduction by nearly an order of magnitude.

There was no significant difference between 0.25, to 50% benzonitrile blends with EMITFSI in terms of the ESR rise rate and Capacitance loss rate. This clearly indicates that the present invention encompasses a wide range of concentrations of stabilising additive.

The operation of the device in this invention is not limited to the temperatures and voltages used in the above examples. It is often convenient to use higher temperatures during device testing as an accelerated test to predict life performance at lower temperatures because testing at lower temperatures would take a prohibitively long time to conduct in the laboratory. Therefore it should be obvious that improved life performance at 70° C. and 2.3 V achieved by using the electrolyte additive will also give improved life performance for devices operating at lower temperatures and/or lower voltage windows.

### Example 2

### Cinnamonitrile Additive

Supercapacitor cells were prepared in a similar way to those described above, with the main differences being that cinnamonitrile (3-phenylacrylonitrile) was substituted for benzonitrile and a 25 μm, high porosity PTFE separator was used. The results for ESR rise rate and capacitance loss rate calculated from the life data between 400 and 600 h are shown in Table 2, below:

TABLE 2
Average ESR and capacitance at different points during life testing at 70° C.
and 2.3 V, with associated change rates (values in parenthesis are standard
deviation), illustrating the benefits of cinnamonitrile addition.

| | % | | | | |
|---|---|---|---|---|---|
| | Cinnamonitrile | Average | | ESR rise | |
| Example | in EMITFSI by | Initial ESR | Initial C (F) | rate (mΩ/ | C loss rate |
| No. | weight | (mΩ) at 23° C. | at 23° C. | 1000 h) | (mF/1000 h) |
| 2.1 | 0 | 46 (3) | 1.01 (0.02) | 14 (2) | 175 (32) |
| 2.3 | 1 | 47 (3) | 0.98 (0.01) | 3.9 (0.7) | 73 (18) |
| 2.5 | 5 | 46 (1) | 0.94 (0.01) | 14 (3) | 29 (9) |
| 2.7 | 25 | 57 (2) | 0.86 (0.02) | 209 (16) | 26 (4) |
| 2.8 | 50 | 68 (3) | 0.86 (0.02) | 576 (109) | 23 (36) |

It can be seen from the above results that the use of cinnamonitrile as a stabilising additive provides a better result in terms of capacitance loss over the life of the supercapacitor than when it is absent. Whilst the ESR rise rate observed is not suppressed by high concentrations of cinnamonitrile, the result is nevertheless significant and would clearly translate into an extended lifetime for the supercapacitor with a high retained capacitance.

Similarly, the use of succinonitrile as a stabilising additive was demonstrated under similar conditions to suppress the ESR rise rate over time and also to minimise capacitance loss.

Combinations of stabilising additives may be used to achieve a desired balance of low ESR rate raise and retained capacitance.

The addition of the stabilising additive, such as benzonitrile, may also improve other properties of the device apart from life performance, such as, reducing the initial device ESR at about room temperature or improving device ESR at low temperatures.

Although the invention has been described with reference to specific examples it will be appreciated by those skilled in the art that the invention may be embodied in many other forms.

1-62. (canceled)

63. An electrolyte system suitable for use in an energy storage device, the electrolyte system comprising an ionic liquid and a stabilizing amount of a stabilizing additive.

64. An electrolyte system according to claim 63 wherein the energy storage device is a supercapacitor.

65. An electrolyte system according to claim 63 wherein the stabilizing additive is provided to stabilize EAR of the energy storage device and/or to stabilize capacitance loss of the energy storage device.

66. An electrolyte system according to claim 63 wherein the stabilizing additive either improves or does not adversely affect other performance characteristics of the ionic liquid.

67. An electrolyte system according to claim 63 wherein the ionic liquid is a TFSI salt, optionally, a Li or EMI TFSI salt.

68. An electrolyte system according to claim 63 wherein the ionic liquid is EMITFSI.

69. An electrolyte system according to claim 63 wherein the stabilizing additive is a water scavenger.

70. An electrolyte system according to claim 63 wherein the stabilizing additive contains a nitrile group and/or an aromatic ring.

71. An electrolyte system according to claim 63 wherein the stabilizing additive is an aromatic nitrile.

72. An electrolyte system according to claim 63 wherein the stabilizing additive is contains a benzene ring and one or more nitrile groups.

73. An electrolyte system according to claim 63 wherein the stabilizing additive is selected from the group consisting of benzonitrile, cinnamonitrile and succinonitrile.

74. An electrolyte system according to claim 63 wherein the stabilizing additive is present in an amount of up to 50% wt/wt.

75. An electrolyte system according to claim 63 wherein the stabilizing additive is present in an amount of more than 50% wt/wt.

76. An energy storage device comprising an electrolyte system comprising an ionic liquid and a stabilizing amount of a stabilizing additive.

77. An energy storage device according to claim 76 in the form of a supercapacitor.

78. An energy storage device according to claim 76 wherein the stabilizing additive is provided to reduce EAR rise rate of the energy storage device and/or to reduce capacitance loss of the energy storage device.

79. An energy storage device according to claim 76 wherein the ionic liquid comprises EMITFSI.

80. An energy storage device according to claim 76 wherein the stabilizing additive results in an initial EAR less than the EAR of an equivalent device without the stabilizing additive and/or an EAR rise rate less than an equivalent device without the stabilizing additive.

81. An energy storage device according to claim 76 having a capacitance at least equivalent to the capacitance of an equivalent device without the stabilizing additive and/or a capacitance decay rate less than that of an equivalent device without the stabilizing additive.

82. An energy storage device according to claim 76 having an EAR rise rate of less than 0.01%/h at 2.3 V and 70° C. and/or a capacitance loss rate of less than 0.006%/h at 2.3 V and 70° C.

83. An electrolyte having a conductivity of more than the conductivity of an equivalent electrolyte without the stabilizing additive.
